(19) United States
(12) Patent Application Publication
(10) Pub. No.: US 2011/0006666 A1
(43) Pub. Date: Jan. 13, 2011

(54) ELECTRON-EMITTING DEVICE, ELECTRON BEAM APPARATUS USING THE ELECTRON-EMITTING DEVICE, AND IMAGE DISPLAY APPARATUS

(75) Inventors: Toshiharu Sumiya, Ebina-shi (JP); Hisanobu Azuma, Hadano-shi (JP); Takanori Suwa, Kawasaki-shi (JP); Hirotomo Taniguchi, Saitama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/793,351

(22) Filed: Jun. 3, 2010

(30) Foreign Application Priority Data
Jul. 8, 2009 (JP) 2009-161326

(51) Int. Cl. H01J 1/62; H01J 1/02

(52) U.S. Cl. 313/496; 313/309

(57) ABSTRACT

In an electron beam apparatus including a lamination electron emitting device, it is an object to enhance electron emission efficiency by controlling an electron emission point at which electrons are emitted. In the device, an insulating member and a gate are formed on a substrate, a recess portion is formed in the insulating member, a protruding portion protruding from an edge of the recess portion toward the gate is provided at an end in opposition to the gate, of a cathode 6 arranged on a side surface of the insulating member, and convex portions at a distance of not less than 1 nm and not more than 5 nm from the gate in a width direction of the protruding portion are included in a density of 10% or less in a width direction of the cathode.

### BACKGROUND OF THE INVENTION

1. Field of the Invention

The present invention relates to an electron beam apparatus for use in a flat panel display, including an electron-emitting device which emits electrons.

2. Description of the Related Art

There has conventionally existed an electron-emitting device, in which a number of electrons emitted from the cathode collide against the gate in opposition to the cathode and are scattered, and thereafter, are taken out as electrons. As the device which emits electrons in such a mode, a surface conduction electron-emitting device and a lamination electron-emitting device are known. Japanese Patent Application Laid-Open No. 2001-167693 discloses the lamination electron-emitting device with the constitution in which a recess portion is provided on an insulating layer in the vicinity of an electron emitting portion.

### SUMMARY OF THE INVENTION

A first aspect of the present invention is an electron-emitting device having an insulating member, a cathode arranged on a surface of the insulating member, and a gate arranged on the surface of the insulating member in opposition to an end of the cathode, and is characterized in that the insulating member has, on the surface thereof, a recess portion at which the end of the cathode is positioned, the end of the cathode includes a protruding portion protruding from an edge of the recess portion on the surface of the insulating member toward the gate, the protruding portion includes a plurality of convex portions at a distance of not less than 1 nm and not more than 5 nm from the gate, the plurality of convex portions are distributed in a density of 10% or less within a length of the protruding portion in a direction along the edge of the recess portion, and an average height h of the convex portions and an average distance λ between adjacent ones of the convex portions meet a relation as follows.

2×h≦λ

A second aspect of the present invention is an electron beam apparatus characterized by including an electron-emitting device of the above described present invention, and an anode, wherein the gate of the electron-emitting device is positioned between the end of the cathode and the anode arranged in opposition thereto.

A third aspect of the present invention is an image display apparatus characterized by including an electron beam apparatus of the above described present invention, and a light-emitting member laminated on the anode.

Further features of the present invention will become apparent from the following description of exemplary embodiments with reference to the attached drawings.

### BRIEF DESCRIPTION OF THE DRAWINGS

FIGS. 1A, 1B and 1C are views schematically illustrating a constitution of an exemplary embodiment of an electron-emitting device of the present invention.

FIG. 2 is a view schematically illustrating a system for measuring the electron emission characteristic of the electron-emitting device of the present invention.

FIG. 3 is a partially enlarged schematic view of the electron-emitting device of FIGS. 1A, 1B and 1C.

FIGS. 4A, 4B and 4C are enlarged schematic views of an electron emitting portion of the electron-emitting device of the present invention and a diagram illustrating a relation of a distance between a gate and a cathode and electron emission efficiency.

FIGS. 5A, 5B, 5C and 5D are diagrams for describing an operational effect of a convex portion provided at a protruding portion of the cathode of the electron-emitting device of the present invention.

FIGS. 6A, 6B, 6C, 6D, 6E, 6F and 6G are schematic sectional views illustrating a manufacturing process of the electron-emitting device of the present invention.

FIG. 7 is a perspective view schematically illustrating a constitution of a display panel of one example of an image display apparatus of the present invention.

FIGS. 8A and 8B are diagrams illustrating a relation of a quantity of film forming of a cathode material and a recess and convex state of the protruding portion of the cathode of the electron-emitting device of the present invention, and a diagram illustrating a relation of sputter pressure and a grain lump size of the cathode material.

FIGS. 9A, 9B and 9C are diagrams illustrating distributions of the distance between the gate and the cathode of the electron-emitting device of example 1 of the present invention, the shape of the convex portion at a cathode end, and the distance of the protruding portions.

FIG. 10 is a diagram illustrating a relation of the distance between the gate and the cathode and a device resistance obtained in example 1 of the present invention.

FIGS. 11A, 11B and 11C are views schematically illustrating a constitution of another embodiment of the electron-emitting device of the present invention.

FIG. 12 is an enlarged schematic view of an electron emitting portion of the electron-emitting device of FIGS. 11A, 11B and 11C.

FIGS. 13A, 13B and 13C are diagrams illustrating distributions of end shapes of the gate and the cathode, the distance between the gate and the cathode, the distance of the convex portions at the cathode end of the electron-emitting device of example 3 of the present invention.

FIGS. 14A, 14B and 14C are views schematically illustrating a constitution of another embodiment of the electron-emitting device of the present invention.

FIG. 15 is a view schematically illustrating a constitution of another embodiment of the electron-emitting device of the present invention.

### DESCRIPTION OF THE EMBODIMENTS

Preferred embodiments of the present invention will now be described in detail in accordance with the accompanying drawings.

An object of the present invention is to enhance electron emission efficiency by controlling an electron emission point at which electrons are emitted, in an electron beam apparatus including a lamination electron emitting device as disclosed in Japanese Patent Application Laid-Open No. 2001-167693.

According to the present invention, electrons are efficiently emitted from convex portions of a cathode end of the electron-emitting device, and can reach an anode, and therefore, the electron emission efficiency is enhanced.

Hereinafter, with reference to the drawings, an exemplary embodiment of the invention will be described in detail. However, the scope of the present invention does not intend to be limited to only the sizes, materials, shapes and relative arrangement of the components described in the embodiment as long as there is no specific description in particular.

The present invention has been earnestly considered so that a part (strong part) where electric field strength increases can be selectively made in an electron-emitting device, and as a result, in an exemplary mode, the position control of an electron emission point in the electron emitting portion is realized with a simple constitution and a stably operation is performed.

The constitution of the electron-emitting device according to the present invention which enables stable emission will be described first by citing an exemplary embodiment.

An electron beam apparatus of the present invention includes an electron-emitting device which emits electrons, and an anode which the electrons emitted from the electron emitting device reach.

The electron-emitting device of the present invention includes a gate and a cathode on a surface of an insulating member so that the ends thereof are in opposition to each other. The insulating member has a recess portion on the surface where the end of the cathode is positioned, and the end of the cathode has a protruding portion protruding from an edge of the recess portion on the surface of the insulating member toward the gate.

The electron beam apparatus of the present invention has the electron-emitting device of the above described present invention, and the anode which is arranged in opposition to the end of the cathode with the gate of the electron-emitting device therebetween.

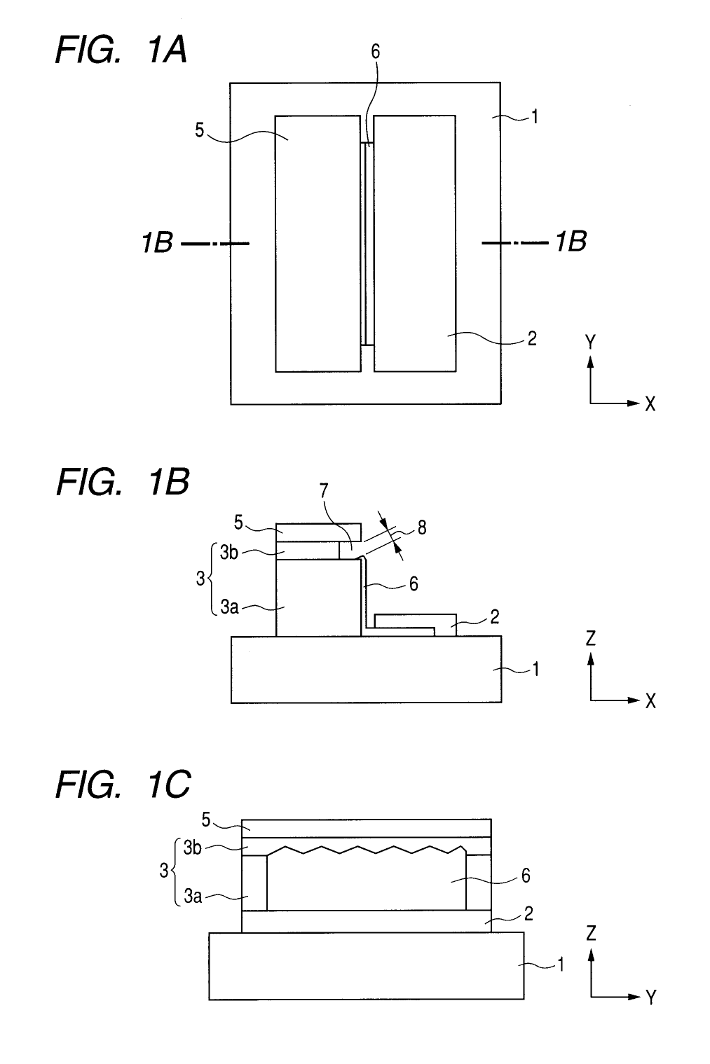

FIG. 1A is a schematic plane view schematically illustrating the constitution of the electron-emitting device of an exemplary embodiment of the present invention. FIG. 1B is a schematic sectional view taken along the 1B-1B line in FIG. 1A. FIG. 1C is a side view of the device seen from the right side of the paper surface in FIG. 1A.

In FIGS. 1A to 1C, the electron-emitting device includes a substrate 1, an electrode 2, and an insulating member 3 which is formed by a laminate of insulating layers 3a and 3b. The electron-emitting device also includes a gate 5, and a cathode 6 which is electrically connected to the electrode 2. A recess portion 7 of the insulating member 3 is formed by recessing only the side surface of the insulating layer 3b inward from the insulating layer 3a in this embodiment. The electric field required for electron emission is formed in a gap 8 (the shortest distance from the end of the cathode 6 to the bottom surface of the gate 5).

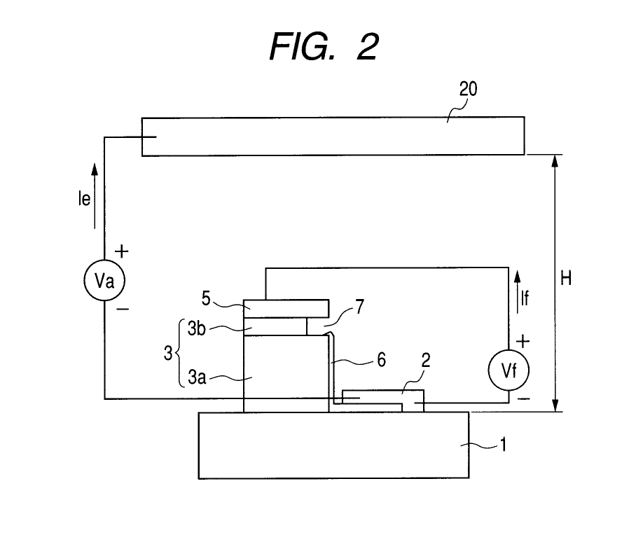

In the electron-emitting device of the present invention, the gate 5 is formed on the surface (top surface in this embodiment) of the insulating member 3, as illustrated in FIGS. 1B and 1C. Meanwhile, the cathode 6 is also formed on the surface (side surface in this embodiment) of the insulating member 3, and has, on the side in opposition to the gate 5 with the recess portion 7 therebetween, a protruding portion protruding from an edge of the recess portion 7 toward the gate 5. Therefore, in the protruding portion, the cathode 6 is in opposition to the gate 5 via the gap 8. In the present invention, the cathode 6 is prescribed to be at a potential lower than the gate 5. Though not illustrated in FIGS. 1A to 1C, the electron-emitting device has an anode which is prescribed to be at a potential higher than the gate 5 and the cathode 6, at a position in opposition to the cathode 6 via the gate 5 (with the gate 5 therebetween) (20 of FIG. 2).

FIG. 2 illustrates feed arrangement of a power supply at the time of measuring the electron emission characteristic of the electron-emitting device of the present invention. As shown in FIG. 2, in the electron beam apparatus of the present invention, the anode 20 is arranged in opposition to the protruding portion of the cathode 6 with the gate 5 therebetween. In this embodiment, the insulating member 3 is arranged on the substrate 1, and therefore, the anode 20 can be said as arranged on the side of the substrate 1, on which the insulating member 3 is arranged, in opposition to the substrate 1.

In FIG. 2, a voltage Vf is applied between the gate 5 and the cathode 6 of the device. A device current If flows at this time. A voltage Va is applied between the cathode 6 and the anode 20. An electron emitting current Ie flows at this time.

Here, an electron emission efficiency η is generally given by efficiency η=Ie/(If+Ie) by using the current If which is detected when a voltage is applied to the device, and the current Ie which is taken out in a vacuum.

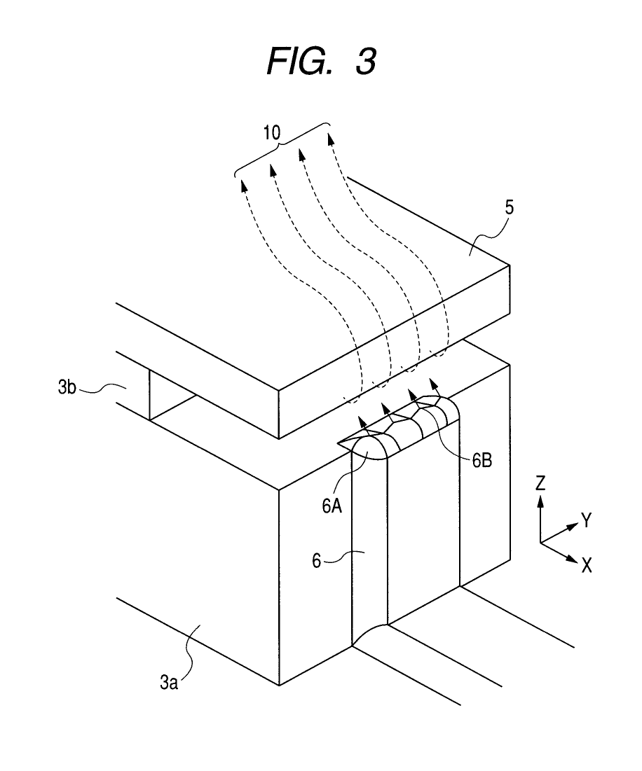

FIG. 3 illustrates an enlarged schematic view of an electron emitting portion. In FIG. 3, the cathode 6 has a protruding portion 6A at the end on the side in opposition to the gate 5. The protruding portion 6A protrudes toward the gate 5 from the edge of the recess portion 7. The electrons which are emitted toward the anode flow in an trajectory 10.

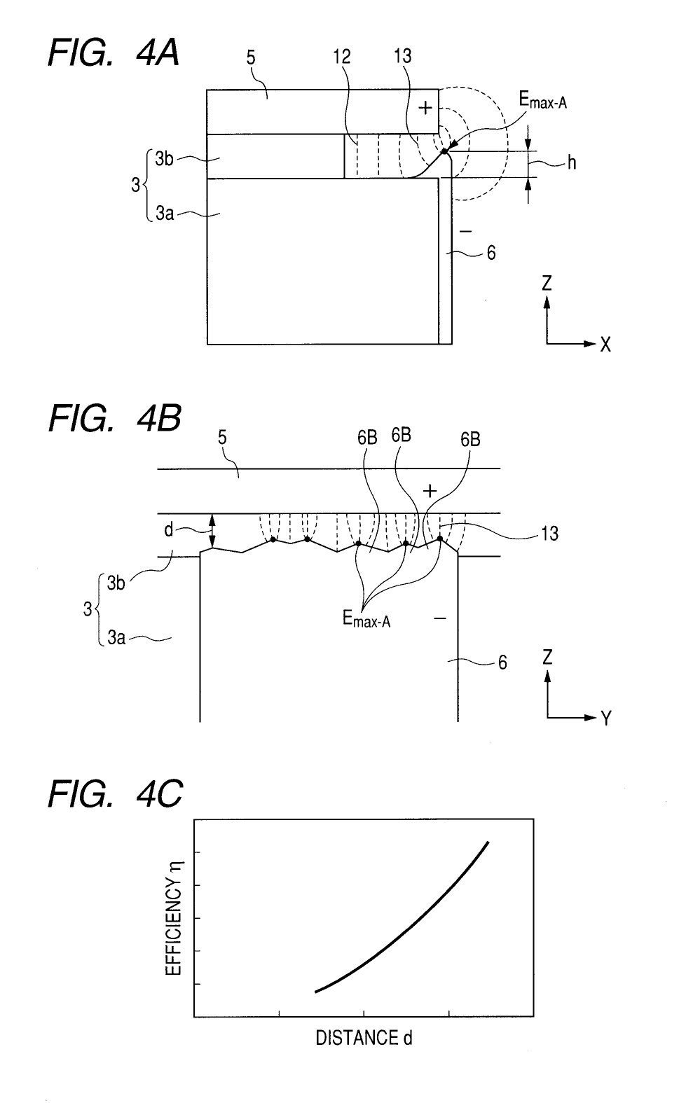

The state of electric field concentration when the drive voltage Vf is applied to the electron-emitting device in the system of FIG. 2 will be described in more detail with use of FIGS. 4A to 4C. FIG. 4A is an enlarged schematic view of the recess portion 7 of FIG. 1B. FIG. 4B is an enlarged schematic view of the recess portion 7 of FIG. 1C. In FIGS. 4A and 4B, broken lines 12 and 13 schematically show electric lines of force formed in the recess portion 7. The intensity of the electric field is determined by the density of the electric lines of force, and the higher the density of the electric lines of force, the stronger the electric field. FIGS. 4A and 4B illustrate only the electric lines of force which are formed in a two-dimensional vacuum region for convenience, but the electric lines of force are actually formed three-dimensionally, and the electric lines of force also spread further into the insulating layers.

As illustrated in FIG. 4A, the protruding portion 6A of the end of the cathode 6 according to the present invention is in the shape protruding from the edge of the recess portion 7 by a height h. As illustrated in FIG. 4A, the electric line of force 12 increases in the density of the electric lines of force at the end of the protruding portion 6A as a result that the electric line of force 13 curves toward the protruding portion 6A formed in the recess portion 7. Accordingly, the electric field at the end of the protruding portion 6A becomes the strongest (E_{max-A}) as the electric field formed in the recess portion 7.

Further, as illustrated in FIG. 4B, in addition to the protruding portion 6A, in the portions where convex portions 6B are present at the end of the protruding portion 6A, the distance to the gate 5 from the end of the protruding portion 6A becomes small by the height of the convex portion 6B. Accordingly, the electric field becomes stronger at the end of the convex portion 6B. Accordingly, when seen in the direction along the edge of the recess portion 7, the electric field at the convex portion 6B becomes the strongest. Therefore, in the electron-emitting device of the present invention, the convex portion 6B is considered to be the electron emitting portion.

Here, the distance between the cathode 6 and the gate 5 in FIG. 4B is set as a distance d. More specifically, the distance d is a distance between the end of the cathode 6 and the gate 5 in an opposing direction (Z direction in the drawing) of the cathode 6 and the anode 20 in FIG. 2. However, depending on the shape of the cathode 6, the actual distance between the cathode 6 and the gate 5 may be larger than the distance measured in the aforementioned direction (Z direction). In such a case, observation and measurement of the distance d and the convex portion can be performed from the angle at which the distance 8 looks the largest. In other words, measurement can be performed from the direction in which the line segment extends, which is orthogonal to the line segment connecting the end of the protruding portion or the convex portion of the cathode and the gate portion in opposition to this. The distance d differs according to the presence or absence of the convex portion 6B and the height of the convex portion 6B, and depending on the locations, since the convex portion 6B is present at the end of the protruding portion 6A of the cathode 6. In the electron-emitting device of the present invention, the convex portion 6B is present, at which the distance d between the cathode 6 and the gate 5 is not less than 1 nm and not more than 5 nm. The reason of this will be described.

From the viewpoint of suppressing the drive voltage required for emitting electrons to 30 V or lower, the distance d between the gate 5 and the cathode 6 may be 5 nm or less. It is considered that if the distance d is 5 nm or less, the electric field strength of 60 MV/cm or more is obtained with the drive voltage of 30 V, and electrons are emitted from the convex portion 6B. Further, from the viewpoint of stability at the time of drive, in the convex portion 6B which becomes the electron emitting portion, the distance d may be 1 nm or more. The convex portion 6B at which the distance d is less than 1 nm is likely to break the device at the time of drive due to field evaporation, discharge and short circuit. Hereinafter, the operational effect of the convex portion 6B according to the present invention will be described in detail.

(Operational Effect of the Convex Portion 6B)

(Description of Scattering in Electron Emission)

In FIG. 3, some of the electrons which are emitted from the convex portion 6B of the cathode 6 toward the gate 5 in opposition to the convex portion 6B isotropically scatter at the end portion of the gate 5, and the remaining electrons are taken outside without colliding with the end portion. However, many of the electrons scatter at the gate 5. As a result that the present inventors studied, it has been found out that there is a positive correlation between the distance d of the cathode 6 and the gate 5, and the electron emission efficiency (η). FIG. 4C illustrates the relation between the distance d and the efficiency. As illustrated in FIG. 4C, if the distance d is too small, electrons scatter at the gate 5, and few electrons are taken out. Further, it is found out that when the distance d becomes large to a certain degree, a positive relation is seen between the distance d and the electron emission efficiency. The reason why a positive correlation is present between the distance d and the electron emission efficiency is considered as follows: as the distance d is smaller, it becomes more difficult for the electrons isotropically scattered at the end portion of the gate 5 to fly outside, whereas as the distance d is larger, it becomes easier for the scattered electrons to fly outside.

As in the present invention, when the convex portion 6B is provided at the end of the protruding portion 6A of the cathode 6, the distance d becomes large around the convex portion 6B, and among the electrons isotropically scattered at the end portion of the gate 5, the electrons scattered to both sides of the convex portion 6B fly in the portions with the large distance d. Accordingly, the electrons are easily taken outside from the area around the convex portion 6B. Therefore, as compared with the case where the protruding portion 6A of the cathode 6 is planarized with respect to the direction (Y direction) along the edge of the recess portion 7 and the distance d is uniform, the anode reaching efficiency can be enhanced. In order to increase the effect of enhancement of the efficiency by the convex portion 6B, it can be said as desirable to make the convex portion 6B higher and enlarge the distance d around the convex portion 6B.

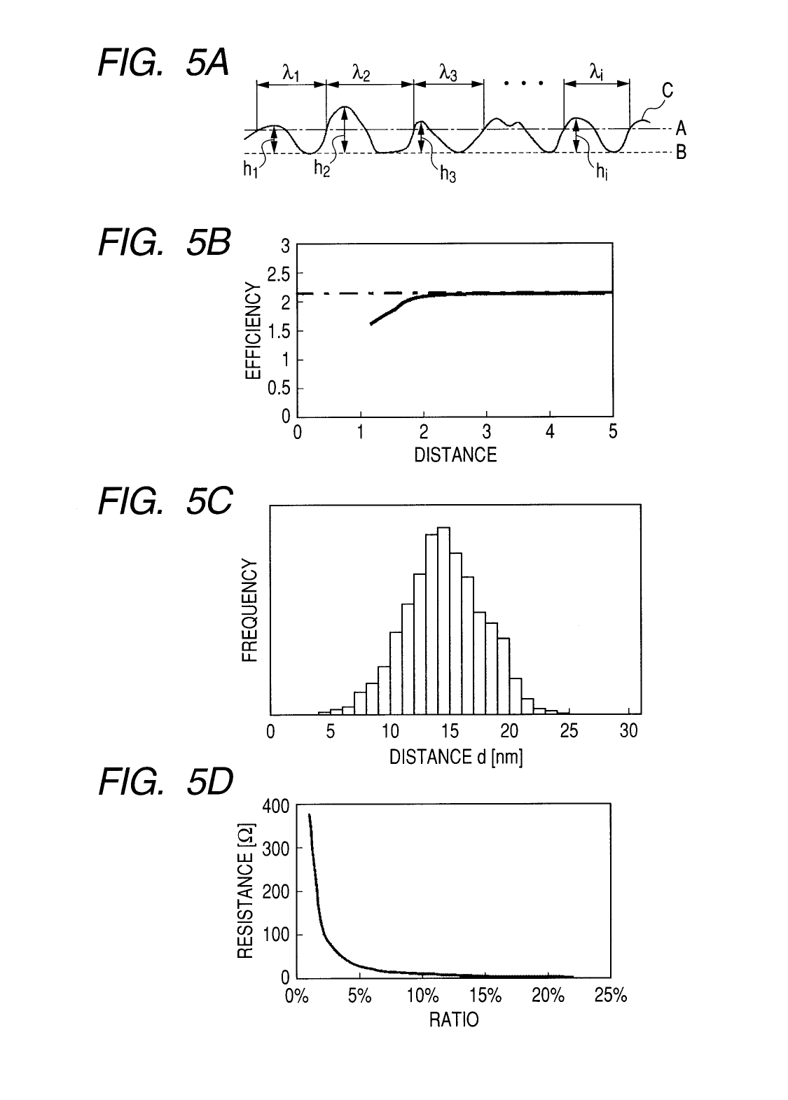

FIG. 5A illustrates an enlarged schematic diagram of the protruding portion 6A. Observation of the protruding portion 6A and the gap 8 between the protruding portion 6A and the gate 5, and measurement of the distance d are performed by observing from the X direction by an SEM.

Separation of the convex portion 6B and the other portion is made by setting the center line (the dashed line A of FIG. 5A) of the outline of the protruding portion 6A seen from the X direction as the reference line. The crest side from the center line A is set as the convex portion 6B.

As shown in FIG. 5A, the distance between the adjacent convex portions 6B is set as λi, and the height (distance in the Z direction from the lowest position B of the protruding portion 6A to the highest position of the convex portion 6B) of the convex portion 6B with respect to the end of the protruding portion 6A is set as hi. By measuring the sufficient numbers of distances λi and heights hi of the convex portions 6B, the average values of them can be obtained. The average distance is set as λ, and the average height is set as h. In the present invention, the average distance λ and the average height h desirably meet a relation of 2×h≦λ. By the above, the influence of the adjacent convex portions 6B can be decreased, and the electron emission efficiency is further enhanced.

FIG. 5B illustrates a relation of the distance λ and the electron emission efficiency η when the height h of the convex portion 6B is fixed, and the distance λ between the adjacent convex portions 6B is changed. The axis of abscissa in the drawing is standardized by the height h. The axis of ordinates is standardized by the efficiency when the protruding portion 6A of the cathode 6 is planerized with respect to the direction (Y direction) along the edge of the recess portion 7, and the distance d from the gate 5 is uniform. The dashed line in the drawing represents the efficiency when only one convex portion 6B is included. From FIG. 5B, as the distance λ of the convex portion 6B is made larger, the electron emission efficiency increases, and gradually approaches the efficiency (broken line) in the case with only one convex portion 6B. When the average distance λ of the adjacent convex portions 6B exceeds double the average height h of the convex portion 6B, the efficiency becomes substantially constant. This is considered to be because the adjacent convex portions are sufficiently separated, and therefore, the influence of the adjacent convex portions decreases.

In the present invention, the ratio of the convex portions 6B which are at distances d of 1 to 5 nm inclusive to the gate 5 from the cathode 6 is desirably made 10% or less of the width of the protruding portion 6A of the cathode 6 in the direction (Y direction) along the edge of the recess portion 7. By limiting the ratio of the small distance d, the possibility of the convex portion 6B and the gate 5 short-circuiting can be reduced. The reason why it is desirable to limit the ratio of the small distance d will be described as follows.

From the viewpoint of the manufacture process and mass productivity, it is considered to be better to allow some variations than to set the distance d and the height h of the convex portion 6B at the same values respectively. FIG. 5C illustrates one example of the distribution of the distance d of the cathode 6 and the gate 5 with respect to the Y direction. The axis of abscissa of FIG. 5C represents the distance d of the cathode 6 and the gate 5, and the axis of ordinates represents the frequency. As the measuring method of the distance d, the method which observes the shapes of the convex portion 6B and the gate 5 by using an SEM is adopted. The distribution as in FIG. 5C is obtained by measuring the distance d of the cathode 6 and the gate 5 of each device with respect to the Y direction, and examining the distribution.

From FIG. 5C, the distribution of the distance d is in the bell shape which is close to the normal distribution. When the average value is small, and the variation is large, it is feared that the current (non-effective current) increases, which flows in the portion at the distance d of zero, that is, between the cathode 6 and the gate 5. In other words, as the ratio of the small distances d becomes higher, the current flowing between the cathode 6 and the gate 5 becomes larger. As a result of the earnest study of the present inventors, it is found out that when the ratio ((distribution) density) of the convex portions 6B at the distance d of 1 to 5 nm inclusive exceeds 10% of the width of the cathode 6, the current flowing between the convex portion 6B and the gate 5 rapidly increases.

FIG. 5D illustrates a relation of the ratio of the convex portions 6B at the distance d of 1 to 5 nm inclusive to the width of the cathode 6, and the resistance of the device. The axis of ordinates represents the resistance value when a plurality of devices are connected. However, the absolute value of the resistance value changes depending on the connection conditions, and therefore, the resistance value of this example is one example. In FIG. 5D, in the region in which the ratio of the convex portions 6B at the distance d of 1 to 5 nm inclusive is 10% or less, as the ratio is smaller, the resistance becomes nonlinearly higher. Meanwhile, when the ratio of the convex portions 6B at the distance d of 1 to 5 nm inclusive exceeds 10%, the resistance becomes relatively low. In the case of this example, the resistance becomes 10Ω or less. When such a ratio exceeds 15%, the resistance becomes substantially zero to about several Ω. This is considered to be because a number of convex portions 6B at the distance d of 0 are included.

If the resistance of the device is small, the current flowing into the gate 5 increases when the device is driven, and electron emission efficiency becomes low. Accordingly, in order to obtain high efficiency, it is necessary to make the ratio of the convex portions 6B where the distance d of the cathode 6 and the gate 5 becomes 1 to 5 nm inclusive 10% or less of the width of the protruding portion 6A in the Y direction. The ratio of the convex portions 6B where the distance d between the cathode 6 and the gate 5 becomes 1 to 5 nm inclusive desirably becomes 0.3 to 10% of the width in the Y direction. This is because if the ratio of the convex portions 6B at the distance d of 1 to 5 nm is too low, the electron emission point cannot be obtained, and a sufficient current cannot be obtained. As a result of the earnest study of the present inventors, when the ratio of the convex portions 6B at the distance d of 1 to 5 nm was not less than 0.3%, the emission point was able to be confirmed reliably when the width in the direction along the edge of the recess portion was several ηm (for example, 3 ηm). Therefore, the (distribution) density of the convex portions 6B in the present invention is not less than 0.3% and not more than 10%.

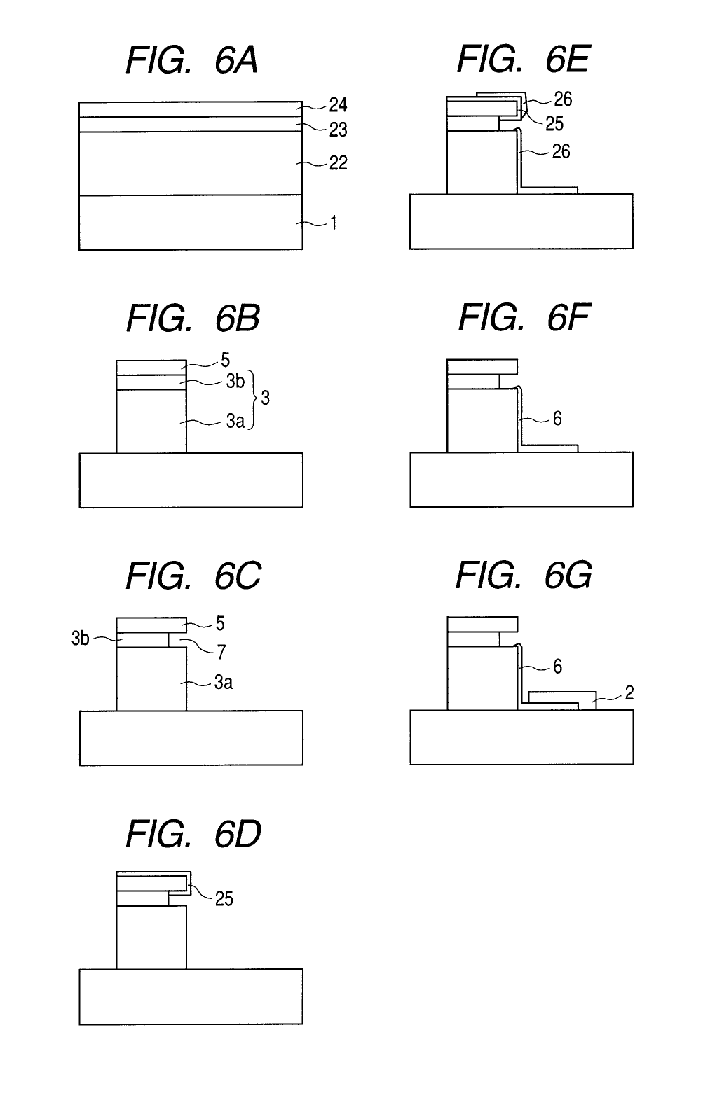

A manufacturing method of the electron-emitting device according to the present invention described above will be described with reference to FIG. 6A to FIG. 6G.

The substrate 1 is an insulating substrate for mechanically supporting the device, and is a quartz glass, a glass with a decreased content of an impurity such as Na, a soda lime glass, and a silicon substrate. As the functions necessary for the substrate 1, not only high mechanical strength, but also resistance against alkali and acid of dry or wet etching and a developing solution are desired, and a small thermal expansion difference from a film forming material and other lamination members is desired when the substrate 1 is used integrally as a display panel. Such a material is desirable that alkali elements and the like from the inside of the glass hardly diffuse with thermal treatment.

First, as shown in FIG. 6A, an insulating layer 22 to be the insulating layer 3a, an insulating layer 23 to be the insulating layer 3b and a conductive layer 24 to be the gate 5 are laminated on the substrate 1. The insulating layers 22 and 23 are insulative films formed from materials excellent in processibility, for example, SiN (SiₓN_{y}) and SiO₂, are formed by the production method such as an ordinary vacuum film forming method such as a sputtering method, a CVD method, or a vacuum vapor deposition method. The thicknesses of the insulating layers 22 and 23 are each set in the range of 5 nm to 50 μm, and can be selected from the range of 50 nm to 500 nm. After the insulating layers 22 and 23 are laminated, the recess portion 7 needs to be formed, and therefore, the insulating layers 23 and 24 have to be set to have different etching amounts for etching. The ratio (selection ratio) of the etching amounts of the insulating layers 22 and 23 is desirably not less than 10, and is more desirably not less than 50. In concrete, SiₓN_{y} is used for the insulating layer 22, for example, and for the insulating layer 23, an insulative material such as SiO₂ is used, or PSG with a high phosphor concentration, a BSG film with a high boron concentration and the like can be used.

The conductive layer 24 is formed by an ordinary vacuum film forming technique such as a vapor deposition method, and a sputtering method. As the conductive layer 24, a material having a high thermal conductivity in addition to electric conductivity and a high melting point can be used. For example, metals or alloy materials of Be, Mg, Ti, Zr, Hf, V, Nb, Ta, Mo, W, Al, Cu, Ni, Cr, Au, Pt and Pd, and carbides such as TiC, ZrC, HfC, TaC, SiC and WC are cited. Further, borides such as HfB₂, ZrB₂, CeB₆, YB₄ and GdB₄, nitrides such as TiN, ZrN, HfN and TaN, semiconductors such as Si and Ge, and organic polymer materials are also cited. Furthermore, amorphous carbon, graphite, diamond-like carbon, carbon in which diamond is diffused and carbon compounds are cited, and the material is properly selected from them.

The thickness of the conductive layer 24 is set in the range of 5 nm to 500 nm, and may be set in the range of 50 nm to 500 nm.

Next, as illustrated in FIG. 6B, after the layers are laminated, a resist pattern is formed on the conductive layer 24 by a photolithography technique, and thereafter, the conductive layer 24, the insulating layer 23 and the insulating layer 22 are sequentially processed by an etching technique. Thereby, the gate 5, and the insulating member 3 including the insulating layer 3b and the insulating layer 3a are obtained.

In such etching processing, RIE (Reactive Ion Etching) is generally used, which is capable of precise etching processing of a material by plasmatizing the etching gas, and irradiating the material with the plasmatized etching gas. As the processing gas at this time, when the object member to be processed makes a fluoride, fluorine gas such as CF₄, CHF₃ and SF₆ is selected. When a chloride is formed like Si and Al, chlorine gas such as Cl₂ and BCl₃ is selected. In order to obtain the selection ratio with the resist, to secure smoothness of the etching surface or enhance the etching speed, hydrogen, oxygen, argon gas and the like are added as the need arises.

As shown in FIG. 6C, by using an etching technique, only the side surface of the insulating layer 3b is partially removed in one side surface of the laminate, and the recess portion 7 is formed.

As the technique of etching, if the insulating layer 3b is of the material formed from SiO₂, for example, a mixed solution of ammonium fluoride and hydrofluoric acid, which is commonly called buffered hydrofluoric acid (BHF), can be used. If the insulating layer 3b is of the material formed from SiₓN_{y}, etching can be performed with a thermal phosphoric acid etching solution.

A depth T6 of the recess portion 7, that is, a distance of the side surface of the insulating layer 3b in the recess portion 7 and the side surfaces of the insulating layer 3a and the gate 5 seriously affects a leak current after device formation, and as the recess portion 7 is made deeper, the value of the leak current becomes smaller. However, if the recess portion 7 is formed to be too deep, the problem of the gate 5 being deformed occurs, and therefore, the recess portion 7 is formed to have a depth of about 30 nm to 200 nm.

In the present embodiment, the mode is shown, in which the insulating member 3 is formed to be a laminate of the insulating layers 3a and 3b, but the present invention is not limited to this, and the recess portion 7 may be formed by removing a part of one insulating layer.

Next, as shown in FIG. 6D, a peeling layer 25 is formed on the surface of the gate 5. Formation of the peeling layer is for the purpose of peeling a cathode material 26 to be deposited in the next step from the gate 5. For such a purpose, the peeling layer 25 is formed by the method which forms an oxide film by oxidizing the gate 5, for example, or the method which causes a peeling metal to adhere to the gate 5 by electrolytic plating.

As shown in FIG. 6E, the cathode material 26 forming the cathode 6 is caused to adhere onto the substrate 1 and the side surface of the insulating member 3. At this time, the cathode material 26 also adheres onto the gate 5.

As the cathode material 26, the material which has conductivity and performs field emission can be used, and the materials can be used, which have high melting points of 2000° C. or higher, and work functions of 5 eV or less, hardly form chemical reaction layers such as an oxide, or are capable of easily removing reaction layers. As such a material, for example, metal or alloy materials of Hf, V, Nb, Ta, Mo, W, Au, Pt and Pd, carbides such as TiC, ZrC, HfC, TaC, SiC and WC, and borides such as HfB₂, ZrB₂, CeB₆, YB₄ and GdB₄ are cited. Further, nitrides such as TiN, ZrN, HfN and TaN, amorphous carbon, graphite, diamond-like carbon, carbon in which diamond is diffused, and carbon compounds are cited.

As the deposition method of the cathode material 26, a general vacuum film forming technique such as a vapor deposition method, and a sputtering method is used, and EB vapor deposition may be used.

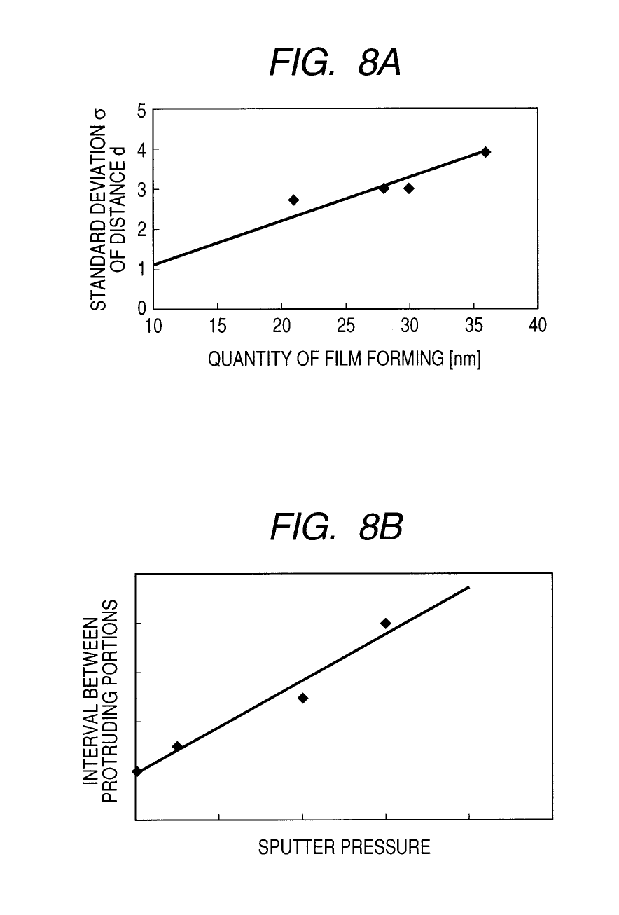

In the present invention, in this step, the protruding portion 6A having the convex portion 6B is formed at the end of the cathode 6. The recess and convex shape of the end of the protruding portion 6A of the cathode 6 depends on the quantity of film forming, for example. FIG. 8A illustrates one example of the quantity of film forming, and the recess and convex state of the protruding portion 6A. As one of the indexes showing such a recess and convex state, a standard deviation σ of the distance d is cited. The standard deviation σ can be calculated from the distribution of the distance d as shown in FIG. 5C. Similarly, from the distribution of FIG. 5C, the ratio of the distance d of 1 to 5 nm can be calculated. In FIG. 8A, the axis of abscissa represents the quantity of film forming, and the axis of ordinates represents the standard deviation σ of the distance d. The quantity of film forming can be controlled by changing the film forming time and the film forming frequency. From FIG. 8A, it can be found out that the recess and convex state (standard deviation σ of the distance d) becomes large according to the quantity of film forming. As the index showing the recess and convex state, the indexes such as an average roughness Ra and the maximum height may be used, besides the standard deviation.

An average value (D) of the distance d also depends on the thickness of the second insulating layer 3b, besides the quantity of film forming. Accordingly, by determining the thickness of the second insulating layer 3b in accordance with the film forming conditions in advance, the average value D of the distance d can be regulated while the recess and convex state is regulated by the film forming conditions. More specifically, by regulating the recess and convex state (the standard deviation σ of the distance d, which depends on the film forming conditions (quantity of film forming) as described above) and the average value D of the distance d, the ratio of the distance d of 1 to 5 nm can be regulated.

As described above, by regulating the thickness of the second insulating layer 3b and the film forming conditions, a desired convex portion 6B is formed at the end of the protruding portion 6A of the cathode 6.

As one example of control of the distance λ of the convex portions 6B, the method is cited, which changes the size of the grain lump after film formation by control of the degree of vacuum at the time of formation. As the size of the grain lump becomes larger, the distance between the adjacent convex portions 6B becomes larger. FIG. 8B illustrates a relation of sputtering pressure and the distance between the adjacent convex portions of the grain lumps. From FIG. 8B, it is found out that as the sputtering pressure is higher (degree of vacuum is lower), the distance λ between the convex portions 6B becomes larger.

Accordingly, in combination with the aforementioned control of the quantity of film forming and the thickness of the insulating layer 3b, the average value D of the distance d of the cathode 6 and the gate 5, the recess and convex state and the height h of the convex portion 6B, and the distance λ of the convex portions 6B can be controlled to be the desired values.

As shown in FIG. 6F, by removing the peeling layer 26 by etching, the cathode material 26 on the gate 5 is removed. The cathode material 26 on the substrate 1 and the side surface of the insulating member 3 is patterned by photolithography or the like, and the cathode 6 is formed.

Next, in order to obtain electrical continuity with the cathode 6, the electrode 2 is formed (FIG. 6G). The electrode 2 has conductivity similarly to the cathode 6, and is formed by an ordinary vacuum film forming technique such as a vapor deposition method, and a sputtering method, and a photolithography technique. As the material of the electrode 2, for example, metal or alloy materials of Be, Mg, Ti, Zr, Hf, V, Nb, Ta, Mo, W, Al, Cu, Ni, Cr, Au, Pt and Pd, and carbides such as TiC, ZrC, HfC, TaC, SiC and WC are cited. Further, borides such as HfB₂, ZrB₂, CeB₆, YB₄ and GdB₄, nitrides such as TiN, ZrN and HfN, semiconductors such as Si and Ge, and organic polymer materials are cited. In addition, amorphous carbon, graphite, diamond-like carbon, a carbon in which diamond is diffused, and carbon compounds are also cited, and the material for the electrode 2 is properly selected from these materials.

The thickness of the electrode 2 is set in the range of 50 nm to 5 mm, and may be selected from the range of 50 nm to 5 μm.

The electrode 2 and the gate 5 may be of the same material or different materials, and may be formed by the same forming method or different forming methods. However, the film thickness of the gate 5 may be set in the thin range as compared with the electrode 2, and may be formed from a low resistance material.

Next, an application mode of the above described electron-emitting device will be described.

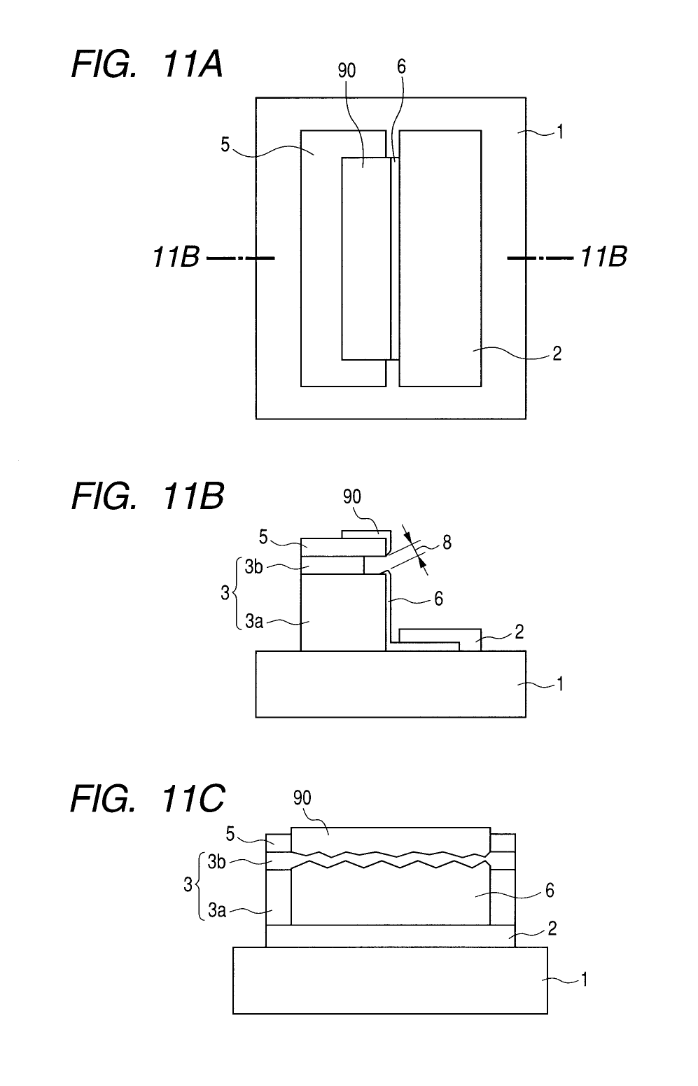

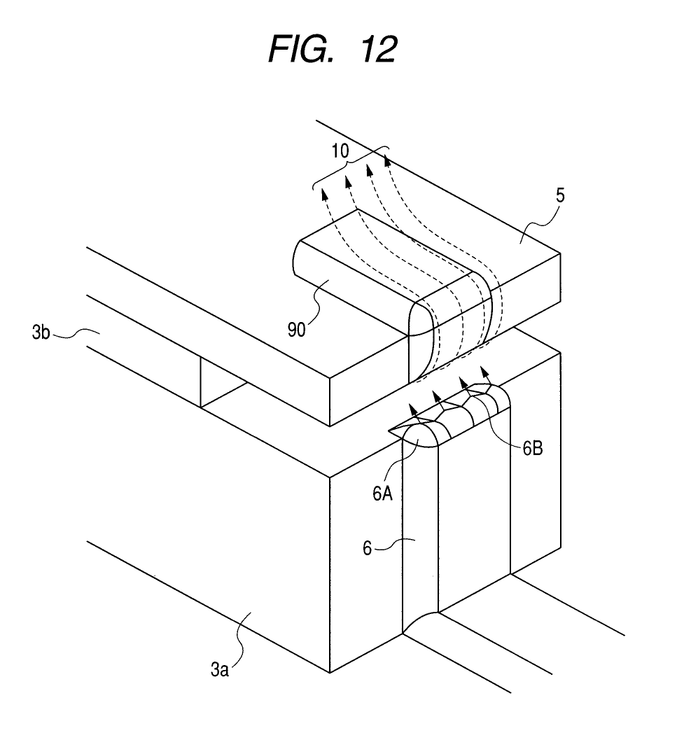

FIGS. 11A to 11C illustrate examples in which the gate 5 has a protruding portion 90 at a portion in opposition to the cathode 6, in the electron-emitting device of the present invention. FIG. 11A is a schematic plane view schematically illustrating the constitution of the electron-emitting device of the present example. FIG. 11B is a schematic sectional view along the 11B-11B line in FIG. 11A. FIG. 11C is a side view of the device seen from the right side of the paper surface in FIG. 11A. FIG. 12 is an enlarged schematic view of the electron emitting portion of the device. In the drawing, the protruding portion 90 is provided at the gate 5.

In FIG. 12, the electrons generating from the end of the cathode 6 collide with the gate 5 and protruding portion 90 in opposition to the cathode 6, and some of the electrons are drawn outside without colliding with the gate 5 and protruding portion 90. Many collided electrons isotropically scatter again at the end portion of the protruding portion 90.

In the device of the present example, a recess and convex shape similar to the protruding portion 6A of the cathode 6 is formed at the end of the protruding portion 90 in opposition to the cathode 6. Therefore, the distance d between the cathode 6 and the gate 5 becomes the distance between the end in the recess and convex shape and the recess and convex shape of the end of the protruding portion 6A of the cathode 6.

As the manufacturing method of the device of the present example, the production step of the peeling layer 25 of FIG. 6D is omitted, and the cathode material 26 is also directly deposited on the gate 5. In the step of FIG. 6F, the cathode material 26 on the substrate 1 and the side surface of the insulating member 3 is patterned to form the cathode 6, and at the same time, the cathode material 26 on the gate 5 can be patterned to form the protruding portion 90.

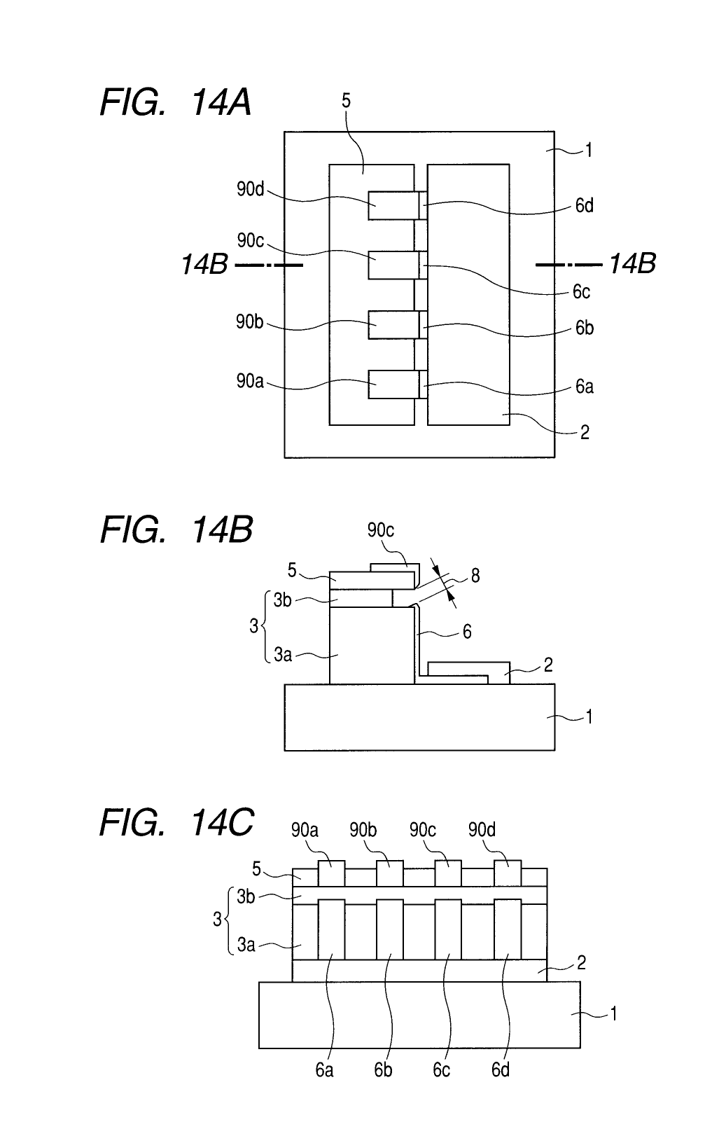

FIGS. 14A to 14C illustrate an example in which a plurality of cathodes 6 and a plurality of protruding portions 90 are disposed with respect to the gate 5, in the electron-emitting device of the present invention. FIG. 14A is a schematic plane view schematically illustrating the constitution of the electron-emitting device of the present example. FIG. 14B is a schematic sectional view along the 14B-14B line in FIG. 14A. FIG. 14C is a side view of the device seen from the right side of the paper surface in FIG. 14A. In the drawings, cathodes 6a to 6d and protruding portions 90a to 90d are illustrated, and the device of FIGS. 14A to 14C are the same as the device of FIGS. 11A to 11C in the constitution except that the cathode 6 and the protruding portion 90 are divided into a plurality of strip shapes, and are arranged with predetermined distances between them.

In the device of the present example, the condition of 2×h≦λ according to the present invention is met in each of the strip-shaped cathodes 6a to 6d.

As the manufacturing method of the device of the present example, the cathode material 26 can be patterned so that the cathode 6 is divided into a plurality of pieces in the step of FIG. 6F.

For a plurality of cathodes 6a to 6d, one protruding portion 90 may be formed like the device of FIGS. 11A to 11C.

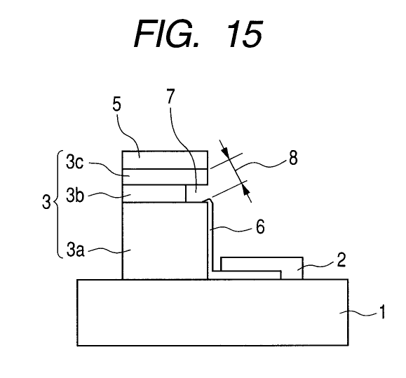

The description of the electron-emitting device according to the above described present invention shows the mode in which the insulating member 3 includes the insulating layers 3a and 3b, and the undersurface of the gate 5 is exposed to the recess portion 7. In the present invention, a mode as illustrated in FIG. 15 may be applied, in which the portion (surface exposed to the recess portion 7 in this example) of the gate 5, which is in opposition to the recess portion, is covered with an insulating layer 3c. In the device of FIGS. 1A to 1C, among the electrons emitted from the cathode 6, the electrons which collide with the bottom surface 5a of the gate 5 do not reach the anode 20, but become the factor (aforementioned If component) which reduces the efficiency. However, in the constitution in which the undersurface of the gate 5 is covered with the insulating layer 3c as in FIG. 15, the If can be reduced, and therefore, the electron emission efficiency is enhanced. As the insulating layer 3c which covers the undersurface of the gate 5, for example, an SiN film of a film thickness of about 20 nm can be used, and it is confirmed that the efficiency enhancing effect can be sufficiently obtained with this constitution. In the constitution of FIG. 15, the insulating member 3 is formed as a laminate including the insulating layers 3a, 3b and 3c, but the recess portion 7 may be formed by removing a part of the insulating layer of one layer.

In the present invention, the constitutions of FIGS. 11A to 11C and FIGS. 14A to 14C can be further combined with the constitution of FIG. 15, the condition setting in each of the constitutions is the same, and the obtained operational effect is also the same.

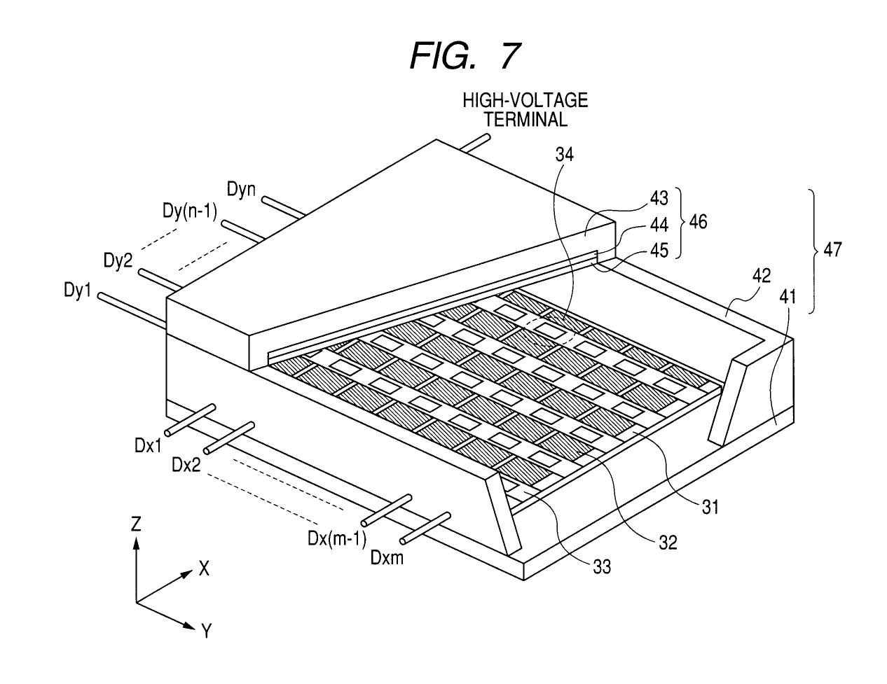

Hereinafter, an image display apparatus including an electron source which is obtained by arranging a plurality of electron-emitting devices of the present invention will be described by using FIG. 7. FIG. 7 is a schematic view illustrating one example of a display panel of the image display apparatus constructed by using an electron source of simple matrix arrangement, which is illustrated in a partially cutout state. FIG. 7 illustrates an electron source substrate 31, an X direction wiring 32, and a Y direction wiring 33, and the electron source substrate 31 corresponds to the substrate 1 of the electron-emitting device which is previously described. An electron-emitting device 34 according to the present invention is also illustrated. The X direction wiring 32 is the wiring commonly connecting the aforementioned electrode 2, and the Y direction wiring 33 is the wiring commonly connecting the aforementioned gate 5.

m of the X direction wirings 32 includes Dx1, Dx2, . . . Dxm, and can be formed from a conductive metal or the like formed by using a vacuum vapor deposition method, a printing method, a sputtering method or the like. The material, film thickness and width of the wiring are properly designed. The Y direction wiring 33 includes wirings Dy1, Dy2, . . . Dyn, and is formed similarly to the X direction wiring 32. An interlayer insulating layer not illustrated is provided between these m of the X direction wirings 32 and n of the Y direction wirings 33, and electrically separates both of them (m and n are both positive integers). The interlayer insulating layers not illustrated is formed from SiO₂ or the like formed by using a vacuum vapor deposition method, a printing method and a sputtering method. The interlayer insulating layer is formed on an entire surface or a part of the electron source substrate 31 on which the X direction wirings 32 are formed, for example, and the film thickness, material and manufacturing method are properly set so that the interlayer insulating layer can withstand a potential difference of the intersection portion of the X direction wiring 32 and the Y direction wiring 33. The X direction wiring 32 and the Y direction wiring 33 are led out as external terminals, respectively.

The electrode 2 and the gate 5 (FIGS. 1A to 1C) are electrically connected to m of the X direction wirings 32 and n of the Y direction wirings 33 by connection wires formed from a conductive metal. The material forming the wiring 32 and the wiring 33, the material forming the connection wire, and the materials forming the electrode 2 and the gate 5 may be the same in a part or all of the constitutional elements, or may be different from one another.

A scanning signal applying unit not illustrated is connected to the X direction wirings 32. The scanning signal applying unit applies a scanning signal for selecting the row of the electron-emitting devices 34 arranged in the X direction. Meanwhile, a modulation signal generating unit not illustrated is connected to the Y direction wirings 33. The modulation signal generating unit modulates each column of the electron-emitting devices 34 arranged in the Y direction according to an input signal. A drive voltage is applied to each of the electron-emitting devices. The drive voltage is supplied as a differential voltage of the scanning signal and the modulation signal which are applied to the device.

In the above described constitution, by using a simple matrix wiring, an individual device is selected, and can be independently driven.

In FIG. 7, a rear plate 41 fixes the electron source substrate 31. In a face plate 46, a phosphor film 44 which is a phosphor as a light emitting member, and a metal back 45 which is the anode 20 are formed on the inner surface of a glass substrate 43. The rear plate 41 and the face plate 46 are mounted on a support frame 42 through a frit glass to form an envelope 47. Sealing by the frit glass is carried out by burning for not less than 10 minutes in the temperature range of 400 to 500° C. under atmosphere or nitrogen.

The envelope 47 is formed by the face plate 46, the support frame 42 and the rear plate 41 as described above. Here, the rear plate 41 is provided for the purpose of reinforcing the strength of the electron source substrate 31, and therefore, when the electron source substrate 31 itself has a sufficient strength, the need of the rear plate 41 as a separate piece can be eliminated. More specifically, the support frame 42 is directly sealed to the electron source substrate 31, and the envelope 47 may be constructed by the face plate 46, the support frame 42 and the electron source substrate 31. Meanwhile, the envelope 17 can be constructed to have sufficient strength with respect to the atmospheric pressure by placing the support not illustrated called a spacer between the face plate 46 and the rear plate 41.

In such an image display apparatus, phosphors are arranged by being aligned on the upper portion of each of the electron-emitting devices 34, in consideration of the trajectory of the emitted electrons. When the phosphor film 44 of FIG. 7 is a colored phosphor film, a black conductive material called a black stripe or a black matrix depending on the arrangement of the phosphors and phosphors can be included.

Next, a constitution example of a drive circuit for performing television display based on the television signal of an NTSC method on the display panel constructed by using the electron sources of simple matrix arrangement will be described.

The display panel is connected to an external electric circuit through terminals Dx1 to Dxm and terminals Dy1 to Dyn, and a high pressure terminal. A scanning signal is applied to the terminals Dx1 to Dxm. The signal is for sequentially driving the electron sources provided in the display panel, that is, an electron-emitting device group wired in a matrix form with m rows and n columns by each row (N devices). Meanwhile, a modulation signal is applied to the terminals Dy1 to Dyn. The modulation signal is for controlling the output electron beam of each of the electron-emitting devices of the one row selected by the scanning signal.

A DC voltage of, for example, 10 [kV] is supplied to the high voltage terminal from a DC voltage source. The DC voltage is an acceleration voltage for giving sufficient energy for exciting a phosphor to the electron beam emitted from the electron-emitting device.

As described above, by application of the scanning signal, the modulation signal, and the high voltage to the anode, the emitted electrons are accelerated and irradiated to the phosphors, and thereby, image display is realized.

By forming such a display apparatus by using the electron-emitting device of the present invention, a display apparatus with the shape of the electron beams in order can be constructed, and as a result, a display apparatus with favorable display characteristics can be provided.

### EXAMPLES

### Example 1

The electron-emitting device of the constitution illustrated in FIGS. 1A to 1C was produced according to the process steps of FIGS. 6A to 6G.

As the substrate 1, PD200 that is a low sodium glass developed for a plasma display was used. As an insulating layer 22, SiN (SiₓN_{y}) was formed to have a thickness of 500 nm by a sputtering method. Next, as an insulating layer 23, an SiO₂ layer of a thickness of 25 nm was formed by a sputtering method. Further, as a conductive layer 24 TaN of a thickness of 30 nm was laminated on the insulating layer 23 by a sputtering method (FIG. 6A).

Next, after a resist pattern was formed on the conductive layer 24 by a photolithography technique, the conductive layer 24, the insulating layer 23 and the insulating layer 22 are sequentially processed by using a dry etching method, and the gate 5 and the insulating member 3 formed from the insulating layers 3a and 3b were formed (FIG. 6B). As the processing gas at this time, CF₄ gas was used since the material for making a fluoride was selected for the insulating layers 22 and 23 and the conductive layer 24. As a result of performing RIE by using the gas, the angles of the insulating layers 3a and 3b and the gate 5 after etched were each formed as an angle of 80° with respect to the horizontal surface of the substrate 1.

After the resist was peeled, the side surface of the insulating layer 3b was etched by using an etching method by using BHF (hydrofluoric acid/ammonium fluoride solution) to make a depth of about 70 nm, and the recess portion 7 was formed in the insulating member 3 (FIG. 6C).

Ni was electrolytically deposited on the surface of the gate 5 by electrolytic plating, and a peeling layer 25 was formed (FIG. 6D).

Molybdenum (Mo) which is a cathode material 26 was caused to adhere onto the gate 5, the side surface of the insulating member 3 and the surface of the substrate 1. In this example, as a film forming method, a sputter vapor deposition method was used. In the present forming method, the angle of the substrate was set to be horizontal with respect to the sputter target. In the sputter film forming of this case, a shielding plate was placed so that the sputter particle may enter the substrate surface at a limited angle. By the shielding plate, peaks were given at the incident angles of 90° and 60° with respect to the horizontal direction. Argon plasma was generated with output power of 3.0 kW and the degree of vacuum of 0.1 Pa, and the substrate was placed so that the distance between the substrate and the Mo target becomes 100 mm or less. When the transfer speed of the substrate was set at 420 nm/min, the film of Mo was formed to be 7 nm by one film forming. By performing film forming five times, the film of Mo was formed, so that the thickness of Mo of a planarized portion became 35 nm (FIG. 6E).

After the film of molybdenum (Mo) was formed, a resist pattern was formed by a photolithography technique so that the width of the cathode 6 became 3 μm. Thereafter, by using a dry etching method, the cathode material 26 was processed, and the cathode 6 was formed. As the processing gas at this time, CF₄ gas was used. Thereafter, by using the etching solution including iodine and potassium iodide, the Ni peeling layer 25 deposited on the gate 5 was removed, and thereby, the Mo film on the gate 5 was peeled (FIG. 6F).

Next, Cu of a thickness of 500 nm was deposited by a sputtering method, and was patterned to form the electrode 2 (FIG. 6G).

After the device was formed by the above method, the electron emission characteristic was evaluated with the constitution illustrated in FIG. 2. As a result, with a drive voltage Vf=24 V, and an anode applied voltage Va=11.8 kV, the average device current If=7.4 μA, the electron-emitting current Ie was 0.3 μA, and the average electron emission efficiency of 4% was obtained. Thus, the electron-emitting device with a sufficient emission current quantity and high efficiency was obtained.

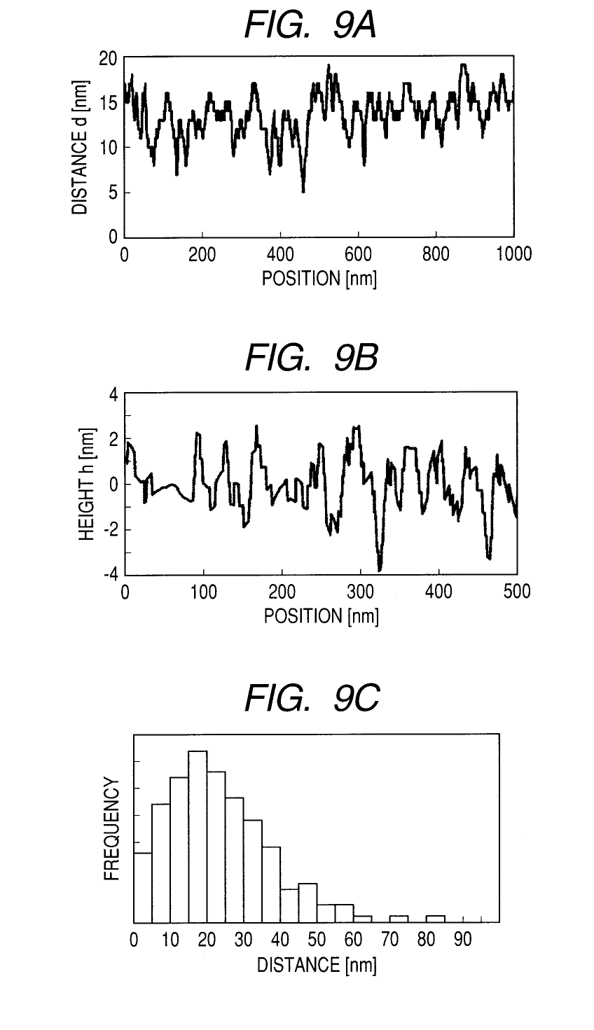

After the characteristics were confirmed, the gap 8 of the cathode 6 and the gate 5 was observed by using an SEM, and analyzed. FIG. 9A illustrates the distance d of the cathode 6 and the gate 5 extracted from the image of the SEM. The axis of abscissa of FIG. 9A represents the position in the direction along the edge of the recess portion 7, and the axis of ordinates represents the distance d of the cathode 6 and the gate 5. In the drawing, waving due to the insulating layer to be the foundation was removed. From the drawing, it is found out that the distance d of the cathode 6 and the gate 5 is not constant but has recesses and convexes. Further, the sizes of the grain lumps of the deposited molybdenum were about 10 to 20 nm.

FIG. 5C illustrates a histogram of the distance d. In FIG. 5C, a plurality of SEM images were photographed, and analyzed. The average distance d between the cathode 6 and the gate 5 of the device of the present example was 13.9 nm, and the standard deviation σ was 3.2 nm. From FIG. 5C, it is considered that the portions at small distances of 1 to 5 nm are present, and electrons are emitted from this region. The ratio of the distances d of 1 to 5 nm was 0.5%.

FIG. 9B illustrates one example of a measurement result of the roughness curve of the protruding portion 6A of the cathode 6. The axis of abscissa of FIG. 9B represents the position in the direction (Y direction) along the edge of the recess portion 7, and the axis of ordinates represents the height h when the center line (dashed line A of FIG. 5A) is set as zero. The roughness curve was obtained by analyzing the image similarly to measurement of the distance d by the aforementioned SEM observation. In order to obtain the average value, the roughness curve as in FIG. 9B was measured at a plurality of spots and analyzed.

The crests and valleys were obtained from the points of intersection where the roughness curve intersects the center line (zero in the drawing). The crest corresponds to the convex portion 6B. From the point of intersection, the period of the crest and valley, that is, the distance λ of the convex portions 6B was obtained. FIG. 9C illustrates the histogram of the distance λ of the convex portions 6B. The average distance λ of the convex portions 6B was about 24 nm. As a result of analyzing the roughness curve illustrated in FIG. 9B at a plurality of spots, and as a result of measuring the average height h of the convex portions 6B with respect to the protruding portion 6A of the cathode 6, the average height h was about 6 nm. The relation of the average height h and the average distance λ of the protruding portions 6B met the relation of 2×h≦λ.

### Comparative Example 1

Next, an example without the convex portions 6B at the distance d of 1 to 5 nm between the cathode 6 and the gate 5 will be shown. The basic production method is similar to that in example 1, and therefore, only the difference from example 1 will be described.

In the present example, the quantity of film forming of molybdenum which was caused to adhere as the cathode material 26 was decreased, and growth of the convex portion 6B was suppressed. In the present example, the transfer speed of the substrate was set at 380 nm/min, and film forming of one time was set to obtain 7.7 nm. By performing film forming three times, the film was formed so that the thickness of Mo on the planarized portion became 23 nm. The thickness of the second insulating layer 3b was set as 20 μm so that the average value of the distance d of the cathode 6 and the gate 5 became similar to that of example 1.

As a result of evaluating the characteristics of the device of the present example similarly to example 1, with the drive voltage Vf=24 V and the anode applied voltage Va=11.8 kV, the average device current If of 0.07 μA, the electron-emitting current Ie of 0.004 μA, and the average electron emission efficiency of 5% were obtained. Though the efficiency was high, a sufficient emitting current was not able to be obtained.

After the characteristics were confirmed, the gap 8 was observed by an SEM similarly to example 1. The average distance d between the cathode 6 and the gate 5 was 13.2 nm, and the standard deviation σ was 2.1 nm. The convex portion 6B at the small distance d of 5 nm or less was not seen. From the roughness curve, the average distance λ of the convex shapes seen in the protruding portion 6A of the cathode 6 was 24 nm, and the average height h of the convex shapes was 4 nm. It is conceivable that in comparative example 1, the convex portion 6B at the small distance d of 1 to 5 nm is not present (the distance d of the cathode 6 and the gate 5 exceeds 5 nm), and therefore, a sufficient current was not obtained though the high efficiency was obtained.

### Comparative Example 2

As comparative example 2, an example of changing the ratio of the portions at the distance d of 1 to 5 nm between the cathode 6 and the gate 5 will be shown. The basic production method is similar to that of example 1, and therefore, only the difference from example 1 will be described. In this example, the thickness of the second insulating layer 3b was increased to 30 nm, and the quantity of film forming which was caused to be adhered as the cathode material 26 was increased to 60 nm, whereby the device was produced. Changing the thickness of the second insulating layer 3b and the quantity of film forming of molybdenum corresponds to changing the ratio of the portions at the distance d of 1 to 5 nm.

As a result of evaluating the characteristics of the device of the present example similarly to example 1, the device with a low resistance was obtained, a current flowed to the gate 5, and electron emission was not obtained. Therefore, the electron emission efficiency became 0%.

After the characteristics were confirmed, the gap was observed by a SEM similarly to example 1. The average distance d between the cathode 6 and the gate 5 was 9.7 nm, and the standard deviation σ was 4.0 nm. The ratio of the portion at the distance d of 1 to 5 nm was 11%. As a result of the observation, the portions where the cathode 6 and the gate 5 were in contact with each other were found in some of the convex portions. The portions where the device was broken due to short circuit were also found.

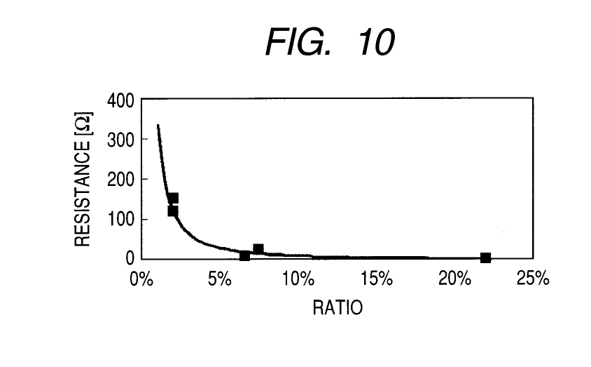

FIG. 10 illustrates a relation of the ratio and the resistance when a prototype was produced by changing the ratio of the portion where the distance d of the cathode 6 and the gate 5 became 1 to 5 nm. From FIG. 10, when the ratio of the portions at the distance d of 1 to 5 nm exceeded 10%, the device with a low resistance was obtained. Meanwhile, when the ratio of the portions at the distance d of 1 to 5 nm was not more than 10%, the device with a high resistance was obtained.

### Example 2

As example 2, the case of changing the thickness of the second insulating layer 3b will be described. The basic production method is similar to that of example 1, and therefore, only the difference from example 1 will be described. In this example, the device was produced by setting the thickness of the second insulating layer 3b to 20 nm, and setting the quantity of film forming of molybdenum to be caused to adhere as the cathode material 26 to 25 nm. Changing the thickness of the second insulating layer 3b and the quantity of film forming of molybdenum corresponds to changing the ratio of the portions at the distance d of 1 to 5 nm.

The characteristics of the device of the present example were evaluated similarly to example 1. As a result, with the drive voltage Vf=24 V and the anode applied voltage Va=11.8 kV, the average device current If was 15.6 μA, the electron-emitting current Ie was 0.78 μA, and the average electron emission efficiency of 5% was obtained, and the electron-emitting device with a sufficient emission current amount and high efficiency was obtained.

After the characteristics were confirmed, the gap was observed by a SEM similarly to example 1. The average distance d between the cathode 6 and the gate 5 was 10.7 nm, and the standard deviation σ was 3.0 nm. The ratio of the small distances d of 1 to 5 nm was 3%. From the roughness curve, the average distance λ of the convex portions 6B of 24 nm, and the average height h of the convex portion 6B of 4 nm met the relation of 2×h≦λ.

### Comparative Example 3

As comparative example 3, an example will be described, in which the average distance λ of the convex portions 6B of the cathode 6 and the average height h of the convex portion 6B do not meet the relation of 2×h≦λ. In the present example, the thickness of the second insulating layer 3b was set at 35 nm. Molybdenum which was caused to adhere as the cathode material 26 was produced by setting the sputter pressure to 0.05 Pa and setting the quantity of film forming to 60 nm.

As a result of evaluating the characteristics of the device of the present example similarly to embodiment 1, with the drive voltage Vf=24 V and the anode applied voltage Va=11.8 kV, the average device current If was 14.5 μA, the electron-emitting current Ie was 0.44 μA, the average electron emission efficiency of 3% was obtained, and the electron-emitting device with low efficiency was obtained.

After the characteristics were confirmed, the gap 8 was observed by a SEM similarly to example 1. The average distance d between the cathode 6 and the gate 5 was 11.7 nm, and the standard deviation σ was 3.6 nm. The ratio of the small distances d of 1 to 5 nm was 3%. From the roughness curve, the average distance λ of the convex portions 6B was about 13 nm, and the average height h of the convex portion was about 8 nm. It is conceivable that in the present example, the relation of the average height h of the convex portion and the average distance λ did not meet the relation of 2×h≦λ, and therefore, the electron emission efficiency reduced.

### Example 3

The electron-emitting device with the constitution illustrated in FIGS. 11A to 11C was produced. In the present example, the device was produced similarly to example 1 except that the peeling layer 25 was not formed in the step of FIG. 6D, and the protruding portion 90 was formed without removing molybdenum (Mo) which is the cathode material 26 adhering onto the gate 5.

After the film of molybdenum (Mo) was formed, a resist pattern was formed by a photolithography technique, so that the width of the cathode 6 and the protruding portion 90 became 3 μm. Thereafter, the cathode 6 and the protruding portion 90 were processed by using a dry etching method. As the processing gas at this time, CF₄ gas was used.

As a result of evaluating the characteristics of the device of the present example similarly to embodiment 1, with the drive voltage Vf=24 V and the anode applied voltage Va=11.8 kV, the average device current If was 8.4 μA, the electron-emitting current Ie was 0.34 μA, and the average electron emission efficiency of 4% was obtained.

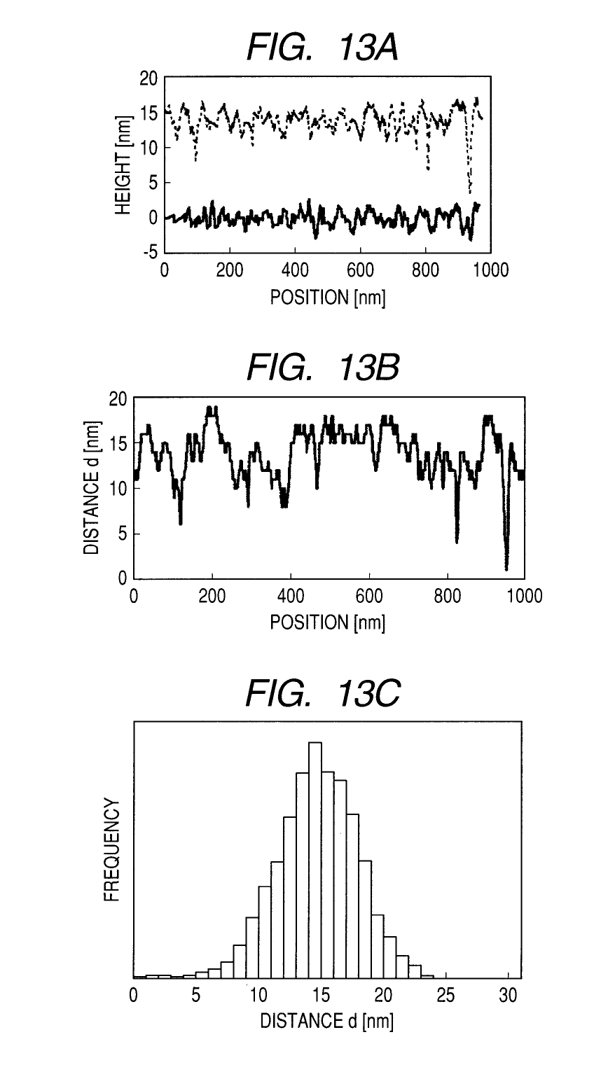

After the characteristics were confirmed, the gap 8 of the cathode 6 and the gate 5 was observed by using a SEM, and analyzed. FIG. 13A illustrates the outlines of the cathode 6 and the protruding portion 90 extracted from the image of the SEM. The outline of the protruding portion 90 is offset to the upper side by the average value of the distance d. From FIG. 13A, not only the cathode 6 but also the protruding portion 90 has recesses and convexes. FIG. 13B illustrates the distance d of the cathode 6 and the protruding portion 90 illustrated in FIG. 13A. From FIG. 13B, it is found out that the distance d of the cathode 6 and the protruding portion 90 is not constant, but has recesses and convexes. FIG. 13C illustrates the histogram of the distance d. In FIG. 13C, a plurality of SEM images were photographed, and analyzed.

The average distance d between the cathode 6 and the protruding portion 90 of the device of the present example was 14.1 nm and the standard deviation σ was 3.2 nm. From FIGS. 13B and 13C, it is considered that the portions at small distances of 1 to 5 nm are present, and electrons are emitted from this region. The ratio of the distances of 1 to 5 nm was 0.2%. From the roughness curve, the average distance λ of the convex portions 6B was about 24 nm, and the average height h of the protruding portion 6B was about 6 nm.

### Example 4

The electron-emitting device with the constitution illustrated in FIGS. 14A to 14C was produced. In the present example, after the film of molybdenum (Mo) was formed, the resist pattern was formed by a photolithography technique so that the width in the Y direction and the gap of the cathode 6 and the protruding portion 90 became a line space of 3 μm. Thereafter, by using a dry etching method, the cathode 6 and the protruding portion 90 were processed. As the processing gas at this time, CF₄ gas was used, since the material which makes a fluoride was selected for the molybdenum used as the cathode material 26. The device was produced similarly to example 3 except for this process step.

As a result of evaluating the characteristics of the device of the present example similarly to embodiment 1, with the drive voltage Vf=24 V and the anode applied voltage Va=11.8 kV, the average device current If was 33.4 μA, the electron-emitting current Ie was 1.3 μA, and the average electron emission efficiency of 4% was obtained.

Considering from the characteristics, the electron-emitting current is assumed to be increased by the number of strips, in other words, by the total lengths of the strips, by forming the cathode 6 into the shape of strips. When the number of strips was increased by 100 times by the similar production method, about a centuple electron emission amount was obtained. Further, when the same number of strips were used, and the width was changed, the electron emission amount proportional to the width of the strip was obtained. After the characteristics were confirmed, the gap 8 of the cathode 6 and the gate 5 was observed by using an SEM, and analyzed. The average distance d between the cathode 6 and the protruding portion 90 was 14.1 nm, and the standard deviation σ was 3.2 nm. It is conceivable that in the present device, portions at the small distances of 1 to 5 nm are present, and electrons are emitted from this region. The ratio of the distance of 1 to 5 nm was 0.2%. From the roughness curve, in each of the strips, the average distance λ of the convex portions 6B of about 24 nm and the average height h of the convex portion 6B of about 6 nm met 2×h≦λ.

### Example 5

In the present example, an electron source substrate was formed by arranging a number of the electron-emitting devices on the substrate in a matrix form by the manufacturing method similar to embodiment 1, and the image display apparatus illustrated in FIG. 7 was produced by using the electron source substrate. The manufacturing process will be described hereinafter.

<Electron Producing Process>

After SiN/SiO₂/TaN/Mo films were sequentially formed on the glass substrate 31, the insulating member 3 having the recess portion 7 was etched similarly to example 1. In the present example, processing of one hundred of comb shapes was performed for one device, and one hundred of strip-shaped cathodes were arranged per one pixel.

<Cathode Formation>

The molybdenum (Mo) which is the cathode material 26 is also caused to adhere onto the gate 5. In the present example, a sputter vapor deposition method was used as the film forming method. In the present forming method, the angle of the substrate was set to be horizontal with respect to the sputter target. In the sputter film forming of the present example, argon plasma was generated at the degree of vacuum of 0.1 Pa so that the sputter particle could enter the substrate surface at a limited angle, and the substrate was placed so that the distance between the substrate and the Mo target was 100 mm or less. The film was formed at the vapor deposition speed of 10 nm/min, so that the Mo thickness of the planarized portion became 35 nm. Thereafter, processing of 100 of strip-shaped Mo was performed by photolithography and etching, and the electron-emitting device was formed.

<Y Direction Wiring Forming Process>

The Y direction wiring 33 was arranged to connect to the gate 5. The Y direction wiring 33 functions as the wiring to which the modulation signal is applied.

<Insulating Layer Forming Process>

In order to insulate the X direction wiring 32 to be produced in the next step and the aforementioned Y direction wiring 33, an insulating layer formed from a silicon oxide was arranged. The insulating layer was arranged to be under the X direction wiring 32 which will be described later, and to cover the Y direction wiring 33 which was formed in advance, and a contact hole was formed by being provided in a part of the insulating layer so as to enable electrical connection of the X direction wiring 32 and the electrode 2 of the aforementioned cathode 6.

<X Direction Wiring Forming Process>

The X direction wiring 32 with silver as a main composition was formed on the insulating layer previously formed. The X direction wiring 32 intersects the Y direction wiring 33 with the insulating layer therebetween, and is connected to the electrode 2 at the contact hole portion of the insulating layer. The X direction wiring 32 functions as the wiring to which a scanning signal is applied. In this manner, the substrate having the matrix wiring was formed.

Next, as illustrated in FIG. 7, the face plate 46 in which the phosphor film 44 and the metal back 45 are laminated on the inner surface of the glass substrate 43 was arranged 2 mm above the substrate 31 via the support frame 47. FIG. 7 illustrates the example in which the rear plate 41 is provided as the reinforcing member of the substrate 31, but in the present example, the rear plate 41 is omitted. The joint portions of the face plate 46, the support frame 42 and the substrate 31 were sealed by heating and cooling indium (In) that is a low-melting metal. The sealing process was performed in the vacuum chamber, and therefore, sealing and sealing were performed at the same time without using an exhaust pipe.

In the present example, in order to realize colors, the phosphor film 44 which is an image forming member was produced by using a stripe-shaped phosphor, forming a black stripe (not illustrated) in advance, and coating the gap portion thereof with a phosphor of each color (not illustrated) by a slurry method. As the material of the black stripe, the material with graphite as a main component which is usually used frequently was used. Further, the metal back 45 formed from aluminum was provided on the inner surface side (electron-emitting device side) of the phosphor film 44. The metal back 45 was produced by vacuum vapor deposition of Al on the inner surface side of the phosphor film 44.

In the image display apparatus of the present example, favorable image display was realized.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-161326, filed Jul. 8, 2009, which is hereby incorporated by reference herein in its entirety.

What is claimed is:

1. An electron-emitting device comprising:
an insulating member;
a cathode arranged on a surface of the insulating member; and
a gate arranged on the surface of the insulating member in opposition to an end of the cathode, wherein
the insulating member has, on the surface thereof, a recess portion at which the end of the cathode is positioned,
the end of the cathode includes a protruding portion protruding from an edge of the recess portion on the surface of the insulating member toward the gate,
the protruding portion includes a plurality of convex portions at a distance of not less than 1 nm and not more than 5 nm from the gate,
the plurality of convex portions are distributed in a density of 10% or less within a length of the protruding portion in a direction along the edge of the concave portion, and
an average height h of the convex portions and an average distance λ between adjacent ones of the convex portions meet a relation: 2×h≦λ.

2. The electron-emitting device according to claim 1, wherein
the plurality of convex portions are distributed in a density of not less than 0.3 and not more than 10%.

3. An electron beam apparatus comprising:
an electron-emitting device according to claim 1;
an anode, wherein
the gate of the electron-emitting device is positioned between the end of the cathode and the anode.

4. An image display apparatus comprising:
an electron beam apparatus according to claim 3; and
a light-emitting member laminated on the anode.
